(19) United States
(12) Patent Application Publication
(10) Pub. No.: US 2017/0295802 A1
(43) Pub. Date: Oct. 19, 2017

(54) TICK AND FLEA CONTROL COMPOSITIONS COMPRISING PLANT ESSENTIAL OILS AND DIFFERENT FORMS FOR THE EASE OF APPLICATION

(71) Applicant: VAMA INC., Keokuk, IA (US)

(72) Inventors: Krishna Prasad Sudhir NAIR, Wlimington, DE (US); Aharsh Rajeswari Padmananbhan SASI, New Delhi (IN)

(73) Assignee: Trident Biotech, Inc., Wilmington, DE (US)

(21) Appl. No.: 15/513,139

(22) PCT Filed: Sep. 22, 2015
(86) PCT No.: PCT/US15/51556

§ 371 Date: Mar. 21, 2017

Related U.S. Application Data
(60) Provisional application No. 62/053,778, filed on Sep. 22, 2014.

(51) Int. Cl. A01N 65/44; A01N 65/22; A01N 65/06; A01N 25/04; A01N 25/30; A01N 25/12; A01N 65/28; A01N 65/08

(52) U.S. Cl. CPC A01N 65/44; A01N 65/28; A01N 65/22; A01N 65/08; A01N 25/04; A01N 25/30; A01N 25/12; A01N 65/06

(57) ABSTRACT

Compositions and methods for controlling fleas and/or ticks are provided herein. Accordingly, it is an object of the present invention to at least provide a new plant based formulation that controls both fleas and ticks, while being safe for pets and humans. It is also an object of the present invention to at least provide a formulation that is entirely biodegradable. It is still another object of the present invention to provide a formulation which minimizes the need for repeat application by maintaining its effectiveness over a period of time beyond the initial application for flea and tick control.

### CROSS REFERENCE TO RELATED APPLICATIONS

This application claims priority to U.S. Provisional Patent Application Ser. No. 62/053,778, filed Sep. 22, 2014, the disclosure of which is hereby incorporated herein by reference in its entirety.

### FIELD

The present invention relates to formulations for control of fleas and ticks. More particularly, the invention relates to a formulation comprising two or more essential oils with other ingredients that provide different forms to the essential oils for the ease of application to control fleas and ticks.

### BACKGROUND

Ticks and fleas are not only annoying to pets but also to humans and can be vectors for disease. As is well known, ticks and fleas are more difficult to control by synthetic insecticide than other insects and similar pests.

Synthetic insecticides can be toxic not only to the pest but also to the animals or people to be protected from the pest. Further, ticks and fleas have developed resistance to several of the insecticides in use.

Use of naturally occurring insecticides has proven to be safe to humans and the animals that they are to benefit. However, their ability to satisfactorily control ticks and fleas is extremely limited.

### SUMMARY OF THE INVENTION

Accordingly, it is an object of the present invention to at least provide a new plant based formulation that controls both fleas and ticks, while being safe for pets and humans. It is also an object of the present invention to at least provide a formulation that is entirely biodegradable. It is still another object of the present invention to provide a formulation which minimizes the need for repeat application by maintaining its effectiveness over a period of time beyond the initial application for flea and tick control. It is another object of this invention to at least provide a formulation that is capable of controlling all species of ticks and fleas. It is a further object to provide a plant-based formulation in different forms so that it can be easily applied on pets. A further object of the present invention is to at least provide insecticidal compositions wherein the active synergistic compositions of the present invention can be employed in a reduced amount and still achieve the desired control over the insects.

These and other objects and features of the invention will be apparent from the description and the claims which follow.

The present disclosure provides an effective formulation that includes plant based active ingredients. It is effective in killing and repelling fleas and ticks. This combination of active ingredients has been observed to enhance the effectiveness of individual ingredients. It is particularly useful for formulations in different forms for ease of application.

The present disclosure provides a composition and different forms of composition that has a pleasant scent and that can be applied without burdensome safety precautions.

The present disclosure provides easy application methods since the insecticidal formulation can be made into different forms.

The present disclosure provides tick and flea control formulations that maintain effectiveness for a period of time after initial application, thereby minimizing the need for repeat application.

The formulations of the present invention effectively control fleas & ticks at absolute component concentrations significantly lower than has previously been disclosed. The ability to effectively control ticks and fleas using dilute preparations results in significant cost savings.

The invention is predicated on the surprising finding that compositions of two or more particular essential oils and/or plant extracts combined with a natural surfactant and synergized with peppermint oil show enhanced activity for repelling and killing fleas and ticks. Without being bound by theory, it is believed that the compositions described herein inhibit and/or activate neuron transmissions by binding at multiple receptors.

Additional objects and attendant advantages of the present invention will be set forth, in part, in the description that follows, or may be learned from practicing or using the present invention. It is to be understood that the foregoing general description and the following detailed description are exemplary and explanatory only and are not to be viewed as being restrictive of the invention, as claimed.

### BRIEF DESCRIPTION OF THE DRAWINGS

FIG. 1 is the tabular summary of the tick mortality after direct spray using Formulation A and Formulation B against Dermacentor andersoni ticks (Rocky Mountain wood tick).

FIG. 2 is the tabular summary of the residual kill activity after direct spray using Formulation A and Formulation B against D. andersoni ticks.

FIG. 3 is the tabular summary of the tick mortality after direct spray using Formulation C and Formulation B against D. andersoni ticks.

FIG. 4 is the tabular summary of the tick mortality after direct spray using Formulation E and Formulation F against D. andersoni ticks.

FIG. 5 is the tabular summary of the residual kill activity after direct spray using Formulation E and Formulation F against D. andersoni ticks.

FIG. 6 is the tabular summary of the flea mortality after direct spray using Formulation A and Formulation B against Ctenocephalides felis (cat fleas).

### DETAILED DESCRIPTION OF THE INVENTION

The flea and tick control compositions of the present invention comprise two or more plant essential oils/plant extract synergized with peppermint oil. The compositions also can include a natural surface acting agent, within which the plant essential oils and/or plant extracts and peppermint oil are solubilized. The surface acting agent can at least serve as an adjuvant and in some instances can act as a co-active ingredient.

In an embodiment of the invention, the composition is in aqueous form and can be applied to a pet using a spray bottle or other applicator. The surface acting agent can at least serve as an adjuvant and in some instances acts as a co-active ingredient.

In an embodiment of the invention, the compositions further may include one or more absorbents in powder form within which the plant essential oils and/or plant extracts and peppermint oil are absorbed. This powder form can be applied to a pet using a powder dispenser.

In another form, the compositions can include a shampoo base, within which the plant essential oils and/or plant extracts and peppermint oil are blended. This can be easily applied using hands.

Plant essential oil/plant extracts that can be used in this technology, apart from peppermint oil, are one or more of geranium oil, lavender oil, cedar wood oil, basil oil, lemon grass oil and tea tree oil, and the like. In some embodiments, one or more of the above-listed materials can be specifically excluded.

In one embodiment of the present technology, the compositions can include or be part of an aqueous formulation wherein the percentage of plant essential oils and peppermint oil is from about 5% to about 10%. The natural surfactant which also can contribute to stability of this formulation can be activated castor oil. The percentage of activated castor can be from about 2% to about 5%. The percentage of water can be from about 85% to about 90%.

In one embodiment of the present technology, the composition can be a powder formulation wherein the percentage of plant essential oils and peppermint oil is from about 5% to about 10%. The percentage of essential oil absorbent is from about 5% to about 10% and the percentage of talcum powder is from about 80% to about 90%. The absorbent may comprise for example fumed silica.

In one embodiment of the present technology, the composition be or include a shampoo wherein the percentage of essential oils and peppermint oil is from about 5% to about 10% and the percentage of shampoo base is from about 90% to about 95%.

Herein the term “naturally occurring ingredients” means plant extracts, plant derived fragrances, flavors, and/or colors.

Herein the term “essential oil” refers to a concentrated hydrophobic liquid containing volatile aroma compounds from plants. Essential oils are also known as volatile oils, ethereal oils, or aetherolea, or simply as the “oil of” the plant from which they are extracted, such as oil of clove. An oil is “essential” in the sense that it carries a distinctive scent, or essence, of the plant.

Herein the term “plant extract” refers to a preparation made by extracting components of a plant using a solvent. Plant extracts include essential oils.

Plant essential oils/plant extracts, which are extracted from natural sources, generally contain, as a major constituent, an acyclic monoterpene alcohol or aldehyde, a benzenoid aromatic compound containing at least one oxygenated substituent or side chain, or a monocarbocyclic terpene generally having a six membered ring bearing one or more oxygenated substituents. Apart from these major constituents there are a number of other components also available in each essential oil.

Some examples of the major constituents of essential oils which can be used in this technology in some embodiments are, without limitation, linalool, limonene, α-terpineol, amyl cinnamic aldehyde, amyl salicylate, anisic aldehyde, cinnamaldehyde, cinnamic alcohol, carvacrol, carveol, citral, citronellal, citronellol, dimethyl salicylate, eucalyptol (cineole), eugenol, iso-eugenol, galaxolide, geraniol, guaiacol, ionone, d-limonene, menthol, methyl anthranilate, methyl ionone, methyl salicylate, alpha-phellandrene, perillaldehyde, piperonal, D-pulegone, terpinen-4-ol, terpinyl acetate, 4-tert butylcyclohexyl acetate, thymol, trans-anethole and vanillin. In some embodiments, one or more of the above listed constituents can be specifically excluded from certain embodiments. The flea and tick control formulations in the present technology can include or consists of at least two or more of the above components with activated castor oil.

Herein the term “surfactant” refers to a compound that lowers the surface tension between two liquids or between a liquid and a solid. Surfactants may act as detergents, wetting agents, emulsifiers, foaming agents, and/or dispersants. Herein, surfactants can allow the oils to disperse in water.

In an embodiment, the surface-active agent can be a natural surfactant. The natural surfactant may also possess a synergistic effect and/or contribute to stability.

In a preferred embodiment, the surface-active agent can be castor oil.

In still another embodiment, the castor oil can be activated, preferably ethoxylated. Activated castor oil is referred to as ethoxylated castor oil. Ethylated castor oil is a by-product of the ethoxylation process where the reactants are castor oil and ethylene oxide. Castor oil is a non-ionic surfactant that is widely used in oral, topical, and prescription formulations. Castor oil may be employed as an emulsifying or solubilizing agent, and is ideal for use in the aqueous preparations of the present invention.

Castor oil is a vegetable-based oil made from castor plant (ricinus communis) seeds. It naturally biodegrades quickly, is non-toxic and comes from a renewable resource (plants). About 90% of castor seed oil contains the unusual hydroxy fatty acid ricinoleate (ricinoleic acid). Ricinoleic acid inhibits the growth of many viruses, bacteria, yeasts, and molds, like its derivative undecylenic acid. It also exerts remarkable analgesic and anti-inflammatory effects. Castor oil is used in products such as adhesives, brake fluids, caulks, cosmetics, drugs, dyes, electrical liquid dielectrics, humectants, hydraulic fluids, inks, lacquers, leather treatments, lubricating greases, machining oils, paints, pesticides-fungicides, pigments, refrigeration lubricants, rubbers, sealants, textiles, washing powders, and waxes. Activated castor oil, also referred to as ethoxylated castor oil, is used in the formulations of the present invention and provides an increased surface acting property as well as extended stability to the formulations.

The insecticidal composition of the present invention can be prepared in various forms, including but not limited to sprayable liquid, powder, and shampoo. Liquid compositions may be prepared in a concentrated form or in a ready-to-use form. A concentrated formulation is primarily a emulsifiable composition in which the castor oil is believed to contribute some level of activity, and is also a solvent and a carrier for essential oils. This composition can be diluted with water before application.

Some embodiments of the invention are formulations in aqueous form.

Some embodiments of the invention are formulations in powder form that can be applied with a powder dispenser.

Herein, the term “talcum powder” or “talc” refers to a mixture preferrably of hydrated magnesium silicate, calcium carbonate and dipropylene glycol.

Some embodiments of the invention are formulations in shampoo form that can be applied directly.

Herein in the term “shampoo base” refers to a mixture preferrably of aloe vera and ethoxylated castor oil.

Compositions of the present invention may be applied on animals, including but not limited to livestock and domestic pets.

Compositions of the present invention are particularly effective and useful to combat fleas and ticks.

In still another embodiment, the formulations of the present invention are target specific, and safe and non-toxic to human beings and other non-target organisms (e.g., pets).

In one embodiment, the composition comprises basil oil. In one embodiment, the concentration of basil oil in the composition is between 0% and about 4.5%. In a preferred embodiment, the concentration of basil oil in the composition is between about 1% and about 4%. In an especially preferred embodiment, the concentration of basil oil in the composition is between about 1.1% and about 4.2%. The amount may be any subrange or value within the indicated ranges, including endpoints.

In a preferred embodiment, the composition comprises peppermint oil. In one embodiment, the concentration of peppermint oil in the composition is between 1% and about 4%. In a preferred embodiment, the concentration of peppermint oil in the composition is between about 1.5% and about 3.5%. In an especially preferred embodiment, the concentration of peppermint oil in the composition is between about 1.6% and about 3.3%. The amount may be any subrange or value within the indicated ranges, including endpoints.

In one embodiment, the composition comprises lavender oil. In one embodiment, the concentration of lavender oil in the composition is between 0% and about 2.5%. In a preferred embodiment, the concentration of lavender oil in the composition is between about 1% and about 2.5%. In an especially preferred embodiment, the concentration of lavender oil in the composition is between about 1.1% and about 1.8%. The amount may be any subrange or value within the indicated ranges, including endpoints.

In one embodiment, the composition comprises lemongrass oil. In one embodiment, the concentration of lemongrass oil in the composition is between 0% and about 4%. In a preferred embodiment, the concentration of lemongrass oil in the composition is between about 0.5% and about 4%. In an especially preferred embodiment, the concentration of lemongrass oil in the composition is between about 0.8% and about 3.7%. The amount may be any subrange or value within the indicated ranges, including endpoints.

In one embodiment, the composition comprises geranium oil. In one embodiment, the concentration of geranium oil in the composition is between 0% and about 2.5%. In a preferred embodiment, the concentration of geranium oil in the composition is between about 0% and about 1.8%. In an especially preferred embodiment, the concentration of geranium oil in the composition is between about 0% and about 1.5%. The amount may be any subrange or value within the indicated ranges, including endpoints.

In one embodiment, the composition comprises cedarwood oil. In one embodiment, the concentration of cedarwood oil in the composition is between 0% and about 2%. In a preferred embodiment, the concentration of cedarwood oil in the composition is between about 0% and about 1%. In an especially preferred embodiment, the concentration of cedarwood oil in the composition is between about 0.4% and about 1%. The amount may be any subrange or value within the indicated ranges, including endpoints.

In one embodiment, the composition comprises tea tree oil. In one embodiment, the concentration of tea tree oil in the composition is between 0% and about 2.5%. In a preferred embodiment, the concentration of tea tree oil in the composition is between about 0% and about 2%. In an especially preferred embodiment, the concentration of tea tree oil in the composition is between about 0% and about 1.5%. The amount may be any subrange or value within the indicated ranges, including endpoints.

In one embodiment, the composition further comprises one or more surfactants. In one embodiment, the concentration of surfactant in the composition is between 0% and about 10%. In a preferred embodiment, the concentration of surfactant in the composition is between about 0% and about 8%. In an especially preferred embodiment, the concentration of surfactant in the composition is between about 2% and about 8%. The amount may be any subrange or value within the indicated ranges, including endpoints.

In one aspect, the composition is in powder form. In one embodiment, the composition further comprises one or more absorbants in powder form. Absorbants include, without limitation, fumed silica and talc. In one embodiment, the amount of absorbant in the composition is between 0% and about 99%. In a preferred embodiment, the amount of absorbant in the composition is between about 0% and about 95%. In an especially preferred embodiment, the amount of absorbant in the composition is between about 50% and about 90%. The amount may be any subrange or value within the indicated ranges, including endpoints.

In one embodiment, the amount of fumed silica is between about 0% and about 15%. In one embodiment, the amount of fumed silica is between about 0% and about 10%. In a preferred embodiment, the amount of fumed silica in the composition is between about 5% and about 10%. The amount may be any subrange or value within the indicated ranges, including endpoints.

In one aspect, the composition is in shampoo form. In one embodiment, the shampoo comprises aloe vera. In one embodiment, the amount of aloe vera in the composition is between 0% and about 99%. In a preferred embodiment, the amount of aloe vera in the composition is between about 0% and about 95%. In an especially preferred embodiment, the amount of aloe vera in the composition is between about 50% and about 90%. The amount may be any subrange or value within the indicated ranges, including endpoints.

In some embodiments, one or more of the components (including the ranges, subranges and specific values) described herein can be specifically excluded from the compositions and/or methods of use for fleas and ticks described herein.

In some aspects of the invention, the composition is a concentrated formulation. The concentrated formulation is diluted in a suitable diluent, e.g. water, prior to application to a surface or an animal. Concentrated formulations will have higher concentrations than the ready-to-use formulations described herein. For example, the concentrated formulation may be 2 times, 3 times, 4 times, 5 times, 10 times, 20 times, 40 times, 50 times, or 100 times more concentrated than the formulations described herein, or any range, subrange, or value between any of these values.

In one aspect, a method of controlling a pest infestation is provided. In one embodiment, the method comprises applying a composition as described herein to a target (e.g. a surface or an animal). In a preferred embodiment, the pest is a flea and/or a tick. In one embodiment, the pest is a flea. In one embodiment, the pest is a tick. In one embodiment, the target is the target can be one or more of a room, an office, a bed, a piece of furniture, a collar, human or animal clothing, footwear (e.g., shoes, socks, boots, etc.), a leash, an animal bed, a sheet, a blanket, a pillow, a field, a yard, a playground, a livestock, a garden, a human, and an animal.

Some embodiments relate to substrates comprising or more of the compositions described herein. For example, the substrate can be any one or more of the following a room, an office, an interior or exterior room or structure, a bed, a piece of furniture, a collar, human or animal clothing, footwear (e.g., shoes, socks, boots, etc.), a leash, an animal bed, a sheet, a blanket, a pillow, other bedding a field, a yard, a playground, a livestock, a garden, a human, and an animal. In some embodiments the substrate can be a reservoir or container that can contain the composition and release it to the environment, including over time. For example, it can be a bowl that releases aerosol or composition to the environment over 1-24 hours (or any sub value or sub range therein) or over any from 1 day to 30 days, 60 days, 6 months or longer (or any sub value or sub range therein). The container can be a gel pack or package with a closure that can be removed when ready for use. The container can heated or have energy applied to facilitate release of the composition. Some embodiments relate to methods of using the substrates to reduce, repel, treat, eliminate and/or prevent (include reduce the onset of) a flea or tick infestation. Those methods can include the substrate being contacted with a human or animal subject for a period of time prior to contact with a flea or tick, after contact or infestation, etc. for a period of time effective to treat, repel, eliminate, reduce, and/or prevent the infestation.

The present technology is described with reference to the following examples, which are given by way of illustration and should not be construed to limit the scope of the present invention.

The exemplary aqueous formulations are:

Formulation A

| | Percentage |
|---|---|
| Components | (%) |
| Basil Oil | 4 |
| Peppermint Oil | 2.4 |
| Lemongrass Oil | 1.9 |
| Geranium Oil | 1.2 |
| Cedarwood oil | 0.5 |
| Surfactant | 3 |
| Water | 87 |

Formulation B

| | Percentage |
|---|---|
| Components | (%) |
| Basil Oil | 3.1 |
| Peppermint Oil | 3.1 |
| Lavender Oil | 1.5 |
| Lemongrass Oil | 1.3 |
| Tea Tree Oil | 1.0 |
| Surfactant | 4 |
| Water | 86 |

The exemplary powder formulations are:

Formulation C

| | Percentage |
|---|---|
| Components | (%) |
| Lemongrass Oil | 3.5 |
| Peppermint Oil | 2.2 |
| Basil Oil | 2.1 |
| Geranium Oil | 1.2 |
| Tea tree oil | 1 |
| Fumed silica | 8 |
| Talc | 82 |

Formulation D

| | Percentage |
|---|---|
| Components | (%) |
| Geranium Oil | 2.3 |
| Lemongrass | 1.8 |
| Peppermint Oil | 1.8 |
| Basil Oil | 1.2 |
| Lavender Oil | 1.1 |
| Tea tree oil | 1.0 |
| Cedarwood Oil | 0.8 |
| Fumed silica | 10 |
| Talc | 80 |

The exemplary Shampoo formulations are:

Formulation E

| | Percentage |
|---|---|
| Components | (%) |
| Basil Oil | 3.0 |
| Peppermint Oil | 2.8 |
| Geranium Oil | 1.3 |
| Lemongrass Oil | 1.3 |
| Tea Tree Oil | 0.8 |
| Cedarwood | 0.8 |
| Surfactant | 3 |
| Aloevera | 87 |

Formulation F

| | Percentage |
|---|---|
| Components | (%) |
| Peppermint Oil | 2.6 |
| Lavender Oil | 1.8 |
| Basil Oil | 1.8 |
| Geranium Oil | 1.5 |
| Tea tree oil | 1.3 |
| Lemongrass Oil | 1 |
| surfactant | 5 |
| Aloevera | 85 |

### EXAMPLES

### Example 1

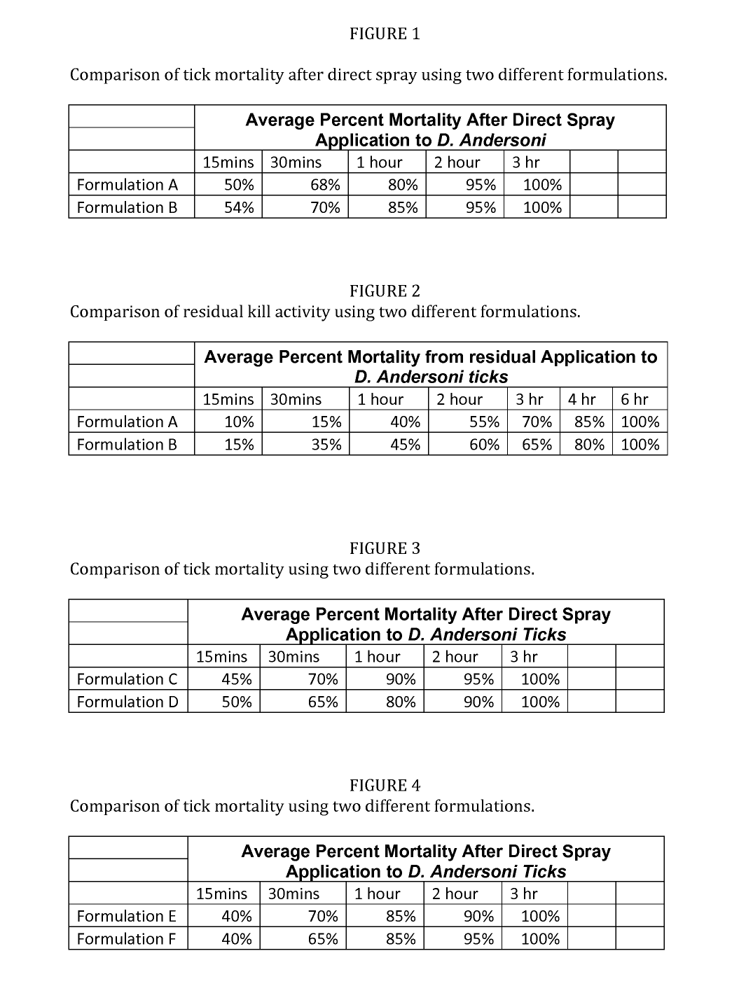

Formulations A and B were compared for their ability to kill and knockdown ticks. The following protocol was utilized and results are shown in FIG. 1. Formulations A and B have 100% kill efficacy in 3 hrs.

1. Whatman #1 Filter paper was cut to size and placed in the bottom of a 100 mm glass petri dish.

2. 10 ticks were transferred to the surface of the filter paper in the glass Petri dish.

3. Formulations (A and B) were applied to the filter paper and insects with a trigger sprayer. Formulations were applied evenly to the surface of the filter paper until wet, but not puddling.

4. The glass lid was placed on the Petri dish to prevent insect escape.

5. Knockdown (KD) and Mortality were scored at 15 mins, 30 mins, 1 hour, 2 hours, 4 hours and 24 hours after application of formulation to insects on the filter paper.

6. Results were repeated 2 times for each formulation.

### Example 2

Formulations A and B were compared for their ability to kill and knockdown ticks. The following protocol was utilized and results are shown in FIG. 2. Formulations A and B have 100% kill efficacy from residual activity (insects coming in contact with dried formulation within 6 hours.
1. Whatman #1 Filter paper was cut to size and placed in the bottom of a 100 mm petri dish.
2. Formulations (Formulation A and Formulation B) were applied to the filter paper with a trigger sprayer (1 pump, Snell trigger sprayer, 1 ml/pull). Formulations were applied evenly to the surface of the filter paper (application made the filter paper wet, but was not so excessive as to cause puddling).
3. The formulation was allowed to dry on the filter paper for 30 minutes.
4. 10 bed bugs were transferred to the surface of the filter paper and lid placed on the Petri dish.
5. Knockdown (KD) and Mortality were scored at 15 mins, 30 mins, 1 hour, 2 hours, 4 hours, 6 hrs and 24 hrs after transfer of insects to the filter paper.
6. Results were repeated 2 times for each formulation.

### Example 3

Formulations C and D were compared for their ability to kill and knockdown ticks. The following protocol was utilized and results are shown in FIG. 3. Formulations C and D have 100% kill efficacy in 3 hrs.
1. Whatman #1 Filter paper was cut to size and placed in the bottom of a 100 mm glass petri dish.
2. 10 ticks were transferred to the surface of the filter paper in the glass Petri dish.
3. Formulations (C and D) were applied to the filter paper and insects with a powder dispenser. Formulations were applied evenly to the surface of the filter paper.
4. The glass lid was placed on the Petri dish to prevent insect escape.
5. Knockdown (KD) and Mortality were scored at 15 mins, 30 mins, 1 hour, 2 hours, 4 hours and 24 hours after application formulation to insects on the filter paper.
6. Results were replicated 2 times for each formulation.

### Example 4

Formulations E and F were compared for their ability to kill and knockdown ticks. The following protocol was utilized and results are shown in FIG. 4. Formulations E and F have 100% kill efficacy in 3 hrs.
1. Whatman #1 Filter paper was cut to size and placed in the bottom of a 100 mm glass petri dish.
2. A 50% dilution of formulations E and F to water were prepared and placed into a clean Trigger Sprayer.
3. 10 ticks were transferred to the surface of the filter paper in the glass Petri dish.
4. Diluted Formulations E and F were applied to the filter paper and insects with a trigger sprayer. Formulations are applied evenly to the surface of the filter paper until wet, but not puddling.
5. The glass lid was placed on the Petri dish to prevent insect escape.
6. Knockdown (KD) and Mortality were scored at 15 mins, 30 mins, 1 hour, 2 hours, 4 hours and 24 hours after application of the formulation to insects on the filter paper.
7. Results were replicated 2 times for each formulation.

### Example 5

Formulations E and F were compared for their ability to kill and knockdown ticks. The following protocol was utilized and results are shown in FIG. 5. Formulations E and F have 100% kill efficacy from residual activity (insects coming in contact with dried formulation within 6 hours.
1. Whatman #1 Filter paper was cut to size and placed in the bottom of a 100 mm petri dish.
2. A 50% dilution of the formulations E and F were diluted to 50% in water and placed into a clean Trigger Sprayer.
3. Diluted Formulations E and F were applied to the filter paper and insects with the trigger sprayer. Formulations were applied evenly to the surface of the filter paper (application made the filter paper wet, but was not so excessive as to cause puddling).
3. The formulation was allowed to dry on the filter paper or 60 minutes.
4. 10 bed bugs were transferred to the surface of the filter paper and lid added to Petri dish.
5. Knockdown (KD) and Mortality were scored at 15 mins, 30 mins, 1 hour, 2 hours, and 4 hours after application formulation to insects on the filter paper.
6. Results were replicated 2 times for each of the formulations.

### Example 6

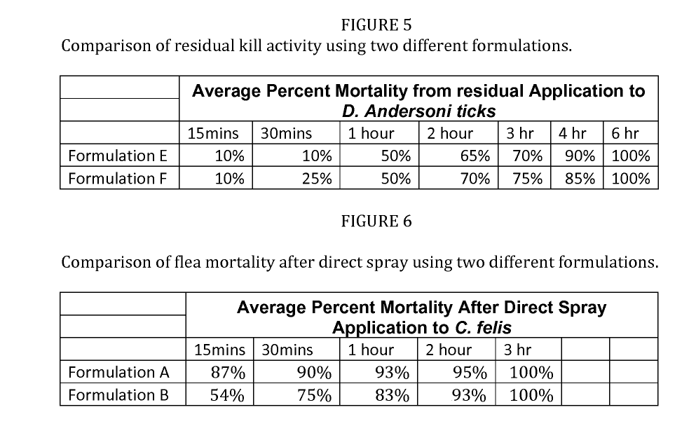

Formulations A and B were compared for their ability to kill and knockdown fleas. The following protocol was utilized and results are shown in FIG. 6. Formulations A and B have 100% kill efficacy in 3 hrs.

1. Whatman #1 Filter paper was cut to size and placed in the bottom of a 100 mm glass petri dish.

2. 10 fleas were transferred to the surface of the filter paper in the glass Petri dish.

3. Formulations (A and B) were applied to the filter paper and insects with a trigger sprayer. Formulations were applied evenly to the surface of the filter paper until wet, but not puddling.

4. The glass lid was placed on the Petri dish to prevent insect escape.

5. Knockdown (KD) and Mortality were scored at 15 mins, 30 mins, 1 hour, 2 hours, 4 hours and 24 hours after application of formulation to insects on the filter paper.

6. Results were repeated 2 times for each formulation.

1. A composition for repelling or killing fleas and/or ticks comprising a water emulsion of plant extracts and a natural surfactant, wherein the plant extracts comprise peppermint oil, geranium oil, lavender oil, cedar wood oil, basil oil, lemon grass oil, tea tree oil, or any combination thereof.

2. (canceled)

3. The composition of claim 1, wherein an individual plant extract is present in an amount of about 5% to about 10% by volume.

4. The composition of claim 1, wherein the natural surfactant is activated castor oil.

5. The composition of claim 1, wherein the natural surfactant is ethoxylated castor oil.

6. The composition of claim 1, wherein the surfactant is present in an amount of about 2% to about 5% by volume.

7. The composition of claim 1, wherein the composition is a water emulsion, aqueous, concentrated, or shampoo form formulation.

8. A composition for controlling fleas and/or ticks comprising by volume 0% to 4.5% basil oil; 1% to 4% peppermint oil; 0% to 2.5% lavender oil; 0% to 4% lemongrass oil; 0% to 2.5% geranium oil; 0% to 2% cedar wood oil; and 0% to 2.5% tea tree oil.

9. The composition of claim 8, comprising about 4% basil oil, about 2.4% peppermint oil, about 1.9% lemongrass oil, about 1.2% geranium oil, about 0.5% cedarwood oil, about 3% surfactant, and about 87% water.

10. The composition of claim 8, comprising about 3.1% basil oil, about 3.1% peppermint oil, about 1.5% lavender oil, about 1.3% lemongrass oil, about 1.0% tea tree oil, about 4% surfactant, and about 86% water.

11. The composition of claim 8, comprising about 3.5% lemongrass oil, about 2.2% peppermint oil, about 2.1% basil oil, about 1.2% geranium oil, about 1.0% tea tree oil, about 8% fumed silica, and about 82% talc.

12. The composition of claim 8, comprising about 2.3% geranium oil, about 1.8% lemongrass oil, about 1.8% peppermint oil, about 1.2% basil oil, about 1.1% lavender oil, about 1.0% tea tree oil, about 0.8% cedarwood oil, about 10% fumed silica, and about 80% talc.

13. The composition of claim 8, comprising about 3.0% basil oil, about 2.8% peppermint oil, about 1.3% geranium oil, about 1.3% lemongrass oil, about 0.8% tea tree oil, about 0.8% cedarwood oil, about 3% surfactant, and about 87% aloe vera.

14. The composition of claim 8, comprising about 2.6% peppermint oil, about 1.8% lavender oil, about 1.8% basil oil, about 1.5% geranium oil, about 1.3% tea tree oil, about 1.0% lemongrass oil, about 5% surfactant, and about 85% aloe vera.

15. A method of controlling fleas and/or ticks, said method comprising applying the composition of claim 1 to a target.

16. The method of claim 15, wherein the target is selected from the group consisting of a room, an office, a bed, a piece of furniture, a field, a yard, livestock, a garden, and an animal.

17-18. (canceled)

19. A substrate comprising the composition of claim 1.

20. The substrate of claim 19, wherein the substrate is selected from the group consisting of office, an interior or exterior structure, a bed, a piece of furniture, a collar, human or animal clothing, footwear, a leash, an animal bed, a sheet, a blanket, a pillow, a field, a yard, a playground, a livestock, a container such that the composition is open to the air but contained within the container (e.g., a bowl, a glass, etc.), a garden, a human, and an animal.
